(19) United States
(12) Patent Application Publication
(10) Pub. No.: US 2011/0182356 A1
(43) Pub. Date: Jul. 28, 2011

(54) A METHOD FOR THE ESTIMATION OF SPATIO-TEMPORAL HOMOGENEITY IN VIDEO SEQUENCES

(76) Inventor: Satya Ghosh Ammu, Hampshire (GB)

(21) Appl. No.: 13/055,887

(22) PCT Filed: Jul. 25, 2008
(86) PCT No.: PCT/EP2008/059816

§ 371 Date: Apr. 11, 2011

(51) Int. Cl. H04N 7/26; H04N 7/32

(52) U.S. Cl. 375/240.03; 375/240.01; 375/240.24; 375/240.16; 375/E07.126; 375/E07.123

(57) ABSTRACT

There is provided a method of encoding video data, comprising estimating the spatio-temporal homogeneity of at least one portion of the video data, providing spatio-temporal homogeneity flags dependent upon the estimated spatio-temporal homogeneity of the at least one portion of the video data, and guiding the encoding process dependent on the spatio-temporal homogeneity flags. There is also provided an apparatus for carrying out the method, and a computer readable product carrying instructions which when executed carry out the method.

### TECHNICAL FIELD

The invention is related to video coding in general, and in particular to pre-processing video to estimate spatio-temporal homogeneity in video sequences.

### BACKGROUND

A successful video coding method delivers a good trade off between picture quality and compression system complexity. Traditional video coding methods such as MPEG2 and MPEG4 employ a block based approach, in which each picture is divided into small square or rectangular groups of pixels known as Macro Blocks. In MPEG2 a macro block typically consists of an array of 16×16 pixels. Each macro block is coded either by exploiting spatial or temporal redundancy as appropriate depending on the conditions within the coder and the behaviour of the picture sequence at that time.

In traditional video encoders, the determination of key coding parameter values, such as motion vectors, mode decisions, quantisation parameter [QP] etc, can be optimised at picture level, slice level (i.e. a horizontal line of macroblocks) or at macro block level. Video coding is therefore an optimisation problem with multiple variables and an optimised coding result will require accurate and reliable measures of picture behaviour and will best be done with picture sequences that are homogeneous both at a global, i.e. picture level, and at macroblock level. Sequences that are highly variable (e.g. due to rapid motion, changes of scene and with flashes present) will not be homogeneous and will result in less efficient coding. In addition, pictures whose detailed content is not consistent at macro block level will result in sub optimal coding due to lack of homogeneity.

An example of such a lack of homogeneity, in the spatial sense, is a macroblock or a set of macroblocks whose pixels exhibit more than one type of behaviour. This behaviour can occur when the pixels of any given macroblock form one or more sets of pixels that correspond to an independent object (such as the foreground and the background, or other objects moving between them) so that as the foreground object(s) moves against the background object(s) the different sets of pixels behave differently. In such a situation it is likely that there will be strong differences in the luminance and chrominance values of these sets of pixels and in the motion vectors that best describes their separate movements. Without regard to this fact, the actual macroblock motion vector selected will be sub-optimal because it will be a combination of these separate motions, which may be conflicting.

The design of compression coding products involves meeting the requirements defined by a standard specification such as MPEG2 or MPEG4. However this use of a standard does not fully constrain the practical coding system designer, and actually leaves a large scope for using novel proprietary techniques to improve performance.

The problem solved by this invention is the basic one of designing an effective and efficient coding product that is also cost effective in its implementation in hardware.

The performance of existing solutions can always be improved and enhanced. In particular, innovation in encoder design resides mainly in a stage of pre-processing that precedes the encoding proper and is not specified in any way by well known standards. The purpose of pre-processing is to accumulate knowledge about the behaviour of the picture sequence being coded so that coding parameter choices can be optimised and so that the video signal itself may be conditioned to make it more amenable to optimum coding quality. Accordingly, the present invention invokes some processing that examines the behaviour of the picture at a detailed level with a view to learning useful information that can effectively help to optimise coding performance.

So the invention seeks to incorporate human visual system models to improve video encoding methods by better exploiting the properties of the intended viewer, in particular, the invention seeks to provide an efficient way of finding homogeneous areas in video sequences with the intent of improving the perceived quality of coded video.

If the parameters of neighbouring macroblocks are compared and rationalised, as described below, then the undesirable aspects of sub-optimal video coding can be ameliorated.

### SUMMARY

In a first aspect of the present invention, there is provided a method of encoding video data, comprising estimating the spatio-temporal homogeneity of at least one portion of the video data, providing spatio-temporal homogeneity flags dependent upon the estimated spatio-temporal homogeneity of the at least one portion of the video data, and guiding the encoding process dependent on the spatio-temporal homogeneity flags.

In this way, the encoding process can take due account of the way in which the Human visual system actually processes data, to provide a higher quality encoded image for a given bit rate.

The process is most usefully applied by assessing each picture in the video data, different portions at a time.

Optionally, the step of estimating the spatio-temporal homogeneity further comprises determining a spatial homogeneity of the portion of the video data and determining a temporal homogeneity of the portion of the video data, separately, and wherein the spatial and temporal homogeneity is separately determined to be any one of: fully homogenous; partially homogenous; or non homogeneous.

Flags are set according to the estimated spatial and temporal homogeneities, where each type (spatial or temporal) have their own flag, and the flag can be any of the above mentioned three states (Full, Partial, none). The subsequent encoding process is then guided by the status of these two flags. Not all possible combinations of flags need have a different effect on the coding, and as such, the same sorts of encoding parameters may be applied across different flags combination sets.

Optionally, the video data comprises pictures having macroblocks, and the portion of video data comprises a sampling window of a predetermined number of macroblocks in a square formation, and a macroblock of interest is located in the centre of said sampling window.

Optionally, the sampling window comprises a square of nine macroblocks having the macroblock of interest surrounded by eight neighbouring macroblocks, and wherein ‘fully homogenous’ comprises the case where the macroblock of interest has spatial or temporal characteristics matching the spatial or temporal characteristics of the eight neighbouring macroblocks; ‘partially homogeneous’ comprises the case where the macroblock of interest has spatial or temporal characteristics matching the spatial or temporal characteristics of at least five of the neighbouring macroblocks; and ‘non homogenous’ comprises all other cases.

Other threshold numbers of macroblocks having the same estimated spatial or temporal parameters may be used instead. In some embodiments, the direction of the partial homogeneity may also be used to further refine subsequent encoding.

Optionally, spatial homogeneity is determined from the absolute difference of the standard deviation of the macroblock of interest and the eight surrounding neighbour macroblocks.

Optionally, the macroblock of interest is considered to be part of a fully spatially homogeneous region if the absolute values of the differences between the standard deviations of the macroblock of interest and each of the eight surrounding neighbour macroblocks is less than or equal to a first predetermined value.

Optionally, the macroblock of interest is considered to be part of a partially spatially homogeneous region if the absolute values of the differences between the standard deviations of the macroblock of interest and at least five of the surrounding neighbour macroblocks is less than or equal to a first predetermined value.

A preferred value for the first predetermined value is 384.

Optionally, the macroblock of interest is considered to be part of a fully temporally homogeneous region if a Manhattan distance between motion vectors of the macroblock of interest and each of the eight surrounding neighbour macroblocks is less than or equal to a second predetermined value.

Optionally, the macroblock of interest is considered to be part of a partially temporally homogeneous region if a Manhattan distance between motion vectors of the macroblock of interest and at least five of the surrounding neighbour macroblocks is less than or equal to a second predetermined value.

A preferred value for the second predetermined value is 12.

Optionally, the method may further comprise guiding a Rate Distortion Optimisation portion of the encoding process dependent on the spatio-temporal homogeneity flags.

In this way, unfavourable encoding mode decisions can be minimised

Optionally, wherein the step of guiding the Rate Distortion Optimisation portion of the encoding process comprises applying a first bias value multiple to the intra encoding mode distortion value. The addition of the bias makes the intra encoding mode a less desirable choice for a given situation than would otherwise be the case.

Optionally, the method may further comprise guiding an Adaptive Quantization Parameter portion of the encoding process dependent on the spatio-temporal homogeneity flags.

Optionally, the Adaptive Quantization Parameter is turned off for the macroblock of interest if it is determined to be spatially fully homogeneous or temporally fully homogeneous.

Optionally, the method may further comprise guiding a motion estimation portion of the encoding process dependent on the spatio-temporal homogeneity flags.

Optionally, the step of guiding the motion estimation portion of the encoding process comprises adding a second bias value to the Sum of Absolute Differences for the macroblock of interest, wherein the second bias value comprises a first threshold whose value is dependent on the spatial homogeneity of the macroblock of interest multiplied by [abs (a horizontal motion vector predictor−a horizontal current motion vector)+abs (a vertical motion vector predictor−a vertical current motion vector)], wherein the first threshold value is dependent on the spatial homogeneity of the macroblock of interest.

According to a second aspect of the invention, there is provided a video encoding apparatus comprising a spatio-temporal homogeneity estimation circuit adapted to carry out the above described spatio-temporal homogeneity based video encoding method. The apparatus may be formed as part of the video encoder proper, or be encapsulated within a pre processing portion of the overall video encoding apparatus

Optionally, the video encoding apparatus further comprises a motion estimation circuit and a one picture delay.

Optionally, the video encoding apparatus may further comprise a distortion scaler, adapted to scale the distortion values of an intra encoding mode of the video encoding apparatus, dependent on the output of the spatio-temporal estimation circuit.

Optionally, the video encoding apparatus may further comprise an encoding mode selection circuit adapted to select a macroblock of interest encoding mode dependent on the estimated spatio-temporal homogeneity.

According to a third aspect of the present invention, there is provided a computer-readable medium, carrying instructions, which, when executed, causes computer logic to carry out any of the above described spatio-temporal homogeneity based video encoding, or pre-processing.

### BRIEF DESCRIPTION OF THE DRAWINGS

A method of pre-processing video data will now be described, by way of example only, with reference to the accompanying drawings in which:

FIG. 1 shows a macroblock which is part of a fully homogeneous region;

FIG. 2 shows a macroblock which is part of a partially homogeneous region where homogeneity is with the left neighbourhood;

FIG. 3 shows a macroblock which is part of a partially homogeneous region where homogeneity is with the right neighbourhood;

FIG. 4 shows a macroblock which is part of a partially homogeneous region where homogeneity is with the top neighbourhood;

FIG. 5 shows a macroblock which is part of a partially homogeneous region where homogeneity is with the bottom neighbourhood;

FIG. 6 shows an example of full homogeneity in the temporal direction;

FIG. 7 shows an example of partial homogeneity in the temporal direction;

FIG. 8 shows an example of no homogeneity in the temporal direction;

FIG. 9 shows a schematic block diagram of a portion of the hardware adapted to carry out the method according to an embodiment of the invention, in particular the spatio-temporal estimation circuitry;

FIG. 10 shows a schematic block diagram of a Rate Distortion Optimization (RDO) based mode decision circuitry according to an embodiment of the invention;

FIG. 11 shows a macroblock with a spurious motion vector in a flat region.

### DETAILED DESCRIPTION

An embodiment of the invention will now be described with reference to the accompanying drawings in which the same or similar parts or steps have been given the same or similar reference numerals.

Typical television pictures consist of independent groups of objects in the foreground or background and the human visual system (HVS) is able to discern the behaviour of these objects and understand it. The human visual system has a means of recognising individually the objects in the picture, their motions and inter-relationships, etc. It can also retain these relationships as the pictures succeed each other in a sequence. The human visual system can therefore recognise the different objects, recall their expected patterns of behaviour, and observe the actual behaviour of the objects both consciously and sub-consciously, and if the result of comparing these things is not within expected norms, visual artefacts can start to be seen. The human visual system is particularly adapt at spotting “unusual” behaviour in video sequences, born from the evolution of animal visual threat detection.

The human visual system is a highly space variant system, where spatial resolution is highest at the point of fixation/focus. The human visual system uses relative contrast to represent the information seen. So, it is more sensitive to changes in luminance than the absolute value of the luminance.

Human perception of moving objects depends heavily on whether or not the object is being tracked by the eye. Very fast moving objects can't be tracked by the human eye. Perceptual temporal characteristics of moving objects are dependent on the spatial characteristics, thus perceptual spatial-temporal characteristics are non separable. Also, there is a short term memory effect—People are more likely to remember bad quality frames than the good ones.

The homogeneity of objects, if modelled as if perceived by the human visual system, can be exploited to improve the performance of encoded video sequences by optimising the coding parameters at object level. A homogeneous object can be a set of pixels having similar intensity or chrominance levels, or similar motion, or exhibiting both characteristics. The blocking effect observed with the more traditional coding schemes when operating near their failure point is found by experiment to be much reduced with such a homogenous region based approach.

Typically, the objective quality measure Peak Signal to Noise Ratio (PSNR) is widely employed to evaluate digital video quality. This is partly due to the widespread use of analogue Signal to Noise Ratio (SNR) metrics in traditional analogue video measurement, where it worked well and reliably. It is now accepted that the quality of digitally coded pictures as perceived by the human visual system does not correlate well with a global measure such as PSNR. This is because it is not an appropriate measure for dealing with the impairments introduced by complex non-linear digital video processing methods. Therefore, new, more accurate, indicators of quality are needed. The present invention also proposes an indicator that is based on a measure of picture homogeneity at macroblock level.

A typical example of this can be observed in the coding of grass in soccer or other sports sequences, where homogeneous motion vectors are found to improve the human visual system perception of the encoded sequence. Similarly Quantisation Parameter (QP) changes or mode decision changes in homogeneous areas, which in turn cause changes in luminance level, distort the human visual system perception of the sequence as the human visual system perception is more sensitive to luminance contrast than absolute luminance. The human visual system is also less sensitive to chrominance, and this is why video is generally encoded using less bandwidth (bits in digital video) for chrominance values than luminance values. Hence, for example, a macroblock will be encoded for luminance at 16×16 pixels, but only 8×8 for Chrominance (Cr/Cb).

Experiment shows that improvements of perceived picture quality can be achieved by emulating the characteristics of the human visual system insofar as picture homogeneity is concerned.

Regions of images with similar characteristics are defined as homogeneous regions and their characteristics could be expressed through their luminance levels, colour, and motion, etc. The present invention provides an indicator that is based on a measure of picture homogeneity at macroblock level where a macroblock can be considered as a part of homogeneous region, in the context of typical compression methods in widespread use, if the macroblock has similar characteristics to its neighbouring macroblocks in 3 Dimensional or 2 Dimensional spaces.

The described method utilises a sampling window around the macroblock of interest—this is a predetermined number of macroblocks of a particular shape and size which is used to compared to the macroblock of interest, in order to determine the homogeneity of different macroblock selections. It is preferable that the choice of sampling window size is made such that the macroblock of interest is in the centre of the sampling window (i.e. the macroblock length of the sides of the sampling window is a odd number) and that the sampling window comprises a square.

In an exemplary embodiment, at a scale found to be particularly useful in real life tests of the invention given certain performance characteristics (such as performance vs silicon area or Thermal Design Power (TDP)), a sampling window comprising nine macroblocks in a square formation is used. However different sized sampling windows may be used given different performance requirements.

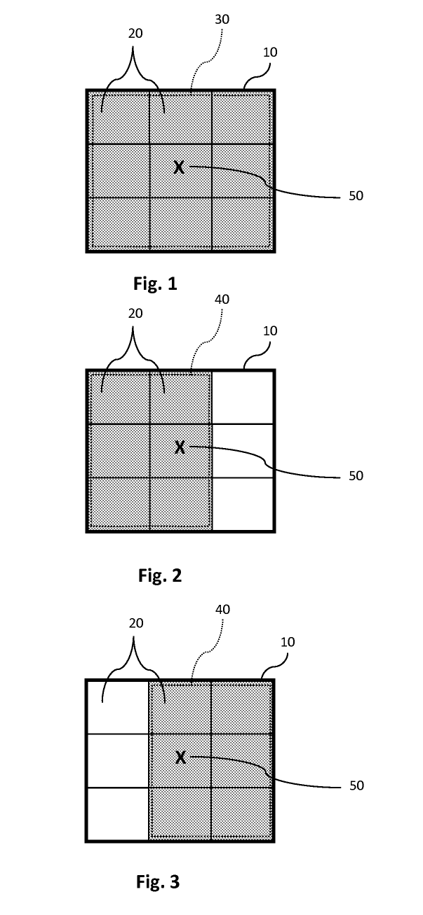

In this case, if the macroblock characteristics match with all eight neighbours, it is considered to be fully homogeneous (as shown in FIG. 1) or partially homogeneous if its characteristics match with 5 of its neighbours (as shown in FIGS. 2, 3, 4 and 5). The direction of partial homogeneity is also derived.

If a macroblock exhibits homogeneity only in spatial direction then it is homogeneous in 2 Dimensional space. If it is homogenous in both spatial and temporal domains then it is homogeneous in 3 Dimensional space. FIGS. 1 to 5 are a generic representation of full/partial homogeneity, in that the partial or full homogeneity may be either temporal or spatial in nature.

FIG. 1 shows a macroblock 50 which is part of a Fully Homogeneous region 30, where each of the macroblocks 20 in the sampling window 10 exhibit the same or similar characteristics.

FIG. 2 shows a macroblock 50 which is part of a Partially Homogeneous region 40, where the partially homogeneous region is in the left neighbourhood of the sampling window 10.

FIG. 3 shows a macroblock 50 which is part of a Partially Homogeneous region 40, where the partially homogeneous region is in the right neighbourhood of the sampling window 10.

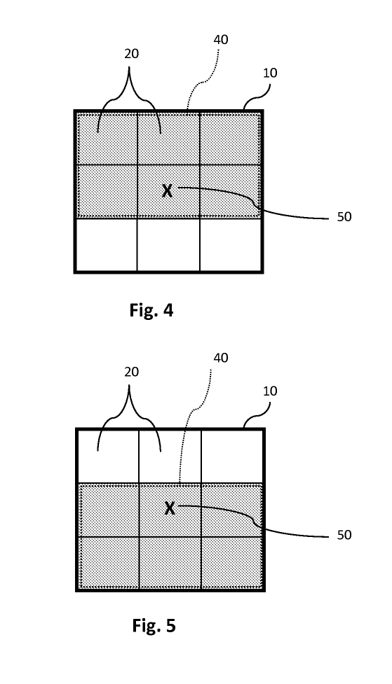

FIG. 4 shows a macroblock 50 which is part of a Partially Homogeneous region 40, where the partially homogeneous region is in the top neighbourhood of the sampling window 10.

FIG. 5 shows a macroblock 50 which is part of a Partially Homogeneous region 40, where the partially homogeneous region is in the bottom neighbourhood of the sampling window 10.

In an embodiment, the direction of the partial homogeneity is not provided to subsequent circuits, such as the encoder. However in other embodiments, the direction of partial homogeneity may be provided as well.

### Criterion for Spatial Homogeneity:

The following definitions apply in calculating the parameter values used in evaluating the criteria for spatial homogeneity, each being based on a calculation over the pixel values of a macroblock:

For every macroblock in the picture, standard deviation is computed from the luma (luminance) and chroma (chrominance) pixel values. Spatial homogeneity is derived from the absolute difference of the standard deviation of the current macroblock and its eight surrounding neighbourhood macroblocks.

Standard deviation of the macroblock is the sum of standard deviation of the luma and both chroma blocks (Cb and Cr). The following pseudo code explains the standard deviation computation:

Luma Mean, M, of the macroblock:
M = (sum of all Luma values of the 16x16 macroblock)/256
Luma Standard Deviation, S, for all 256 luma pixels in the macroblock:
S = Sum abs(luma pixel value − M)
Where abs = absolute function.
Similarly for the Chroma (Cb):
Chroma (Cb) mean, Mcb of the macroblock:
Mcb = (sum of Cb values of the 8x8 macroblock)/64
And the Chroma (Cb) Standard Deviation, Scb, for all 64 chroma Cb
pixels in the macroblock:
Scb = Sum abs(Cb pixel value − Mcb)
Similarly for the Chroma (Cr):
Chroma (Cr) mean, Mcr of the macroblock:
Mcr = (sum of Cr values of the 8x8 macroblock)/64
And the Chroma Cr Standard Deviation, Scr, for all 64 chroma Cr pixels
in the macroblock:
Scb = Sum abs(Cr pixel value − Mcr)
Standard deviation of the macroblock = Luma standard deviation + Cb
Standard deviation + Cr standard deviation.

Any given macroblock (for example MPEG2 16×16 pixels) is considered to be part of a fully homogeneous region if the absolute values of the differences between the standard deviations of the given macroblock and each of its eight immediately surrounding neighbourhood macroblocks are less than or equal to 384. This value is itself advantageous because it has been found by experiment using real life video sequences to produce optimum results. In theory the region around the given macroblock may be extended beyond the eight immediate neighbours, however the additional practical complexity does not return sufficient benefit in coding quality given the increase in coding complexity.

This same given macroblock is partially homogeneous if only five of its neighbours satisfy the above mentioned criterion as shown in FIGS. 2, 3, 4 and 5.

The following pseudo code explains the computation:

Initialize Count to zero;
for( i = 0; I < 8; i++)
{

Standard_deviation_difference = abs(macroblock standard

deviation − neightbourhood[i] macroblock standard deviation);

If( standard_deviation_difference <= 384)
{

Count = Count + 1;

}

}
If(Count is equal to 8)
{

Set Spatially_Homogenity Flag as Fully_Homogenous

}
Else if(count ==5)
{

Set Spatially_Homogenity Flag as Partially_ Homogenous

}
Else

Set Spatial_Homogenity_Flag as zero.

### Criterion for Temporal Homogeneity:

Temporal homogeneity of the macroblock is evaluated using the Manhattan distance between the motion vector of the macroblock under consideration and neighbourhood macroblock's motion vectors.

The Manhattan distance between two vectors A(a0,a1) and B(b0,b1) is defined as abs(a0−b0)+abs(a1−b1).

Any macroblock is considered to be part of a fully homogeneous region if the Manhattan distance between the motion vectors of the given macroblock and each of its eight surrounding neighbourhood macroblocks is less than or equal to 12. This value is itself advantageous because it has been found by experiment to produce optimum results. Again, in theory the region around the given macroblock may be extended beyond the 8 immediate neighbours however the additional practical complexity does not return sufficient benefit in coding quality in Standard Definition resolution video sequences.

This same macroblock is partially homogeneous if only five of its neighbours satisfy the above mentioned criterion as shown in FIGS. 2, 3, 4 and 5.

The following pseudo code explains the computation of temporal homogeneity flag:

Initialize Count to zero;
for( i = 0; I < 8; i++)
{

Read current mb horizontal motion vector in curr_mb_hori_mv;
Read current mb vertical motion vector in curr_mb_verti_mv;
Read neighbourhood[i] horizontal motion vector in

neighbourhood[i]_mb_hori_mv

Read neighbourhood[i] vertical motion vector in

neighbourhood[i]_mb_verti_mv

Manhattan_distance=abs(curr_mb_hori_mv −neighbourhood[i]_mb_hori_mv)

+ abs(curr_mb_verti_mv − neighbourhood[i]_mb_verti_mv)
If(Manhattan_distance <= 12)
{

Count = Count + 1;

}

}
If(Count is equal to 8)
{

Set Temporal_Homogenity Flag as Fully_Homogenous

}
Else if(count ==5)
{

Set Temporal_Homogenity Flag as Partially_ Homogenous

}
Else

Set Temporal_Homogenity_Flag as zero.

As shown above, the each of the two flags (spatial homogeneity flag and temporal homogeneity flag) can have one of three states. Hence their combination produces a total of nine possible outcomes. However, not all outcomes need be used in a particular implementation.

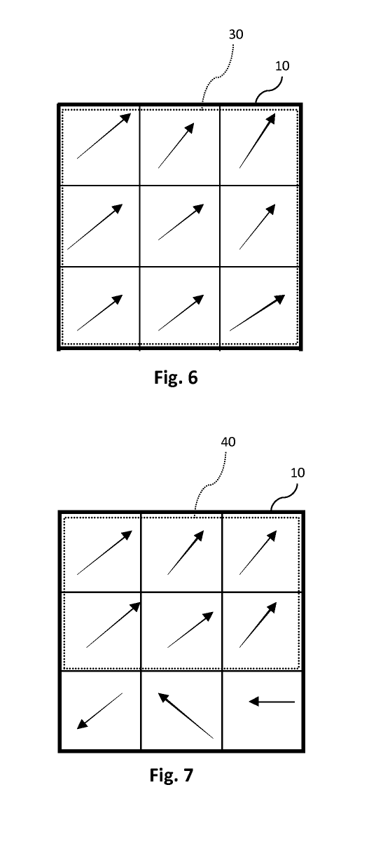

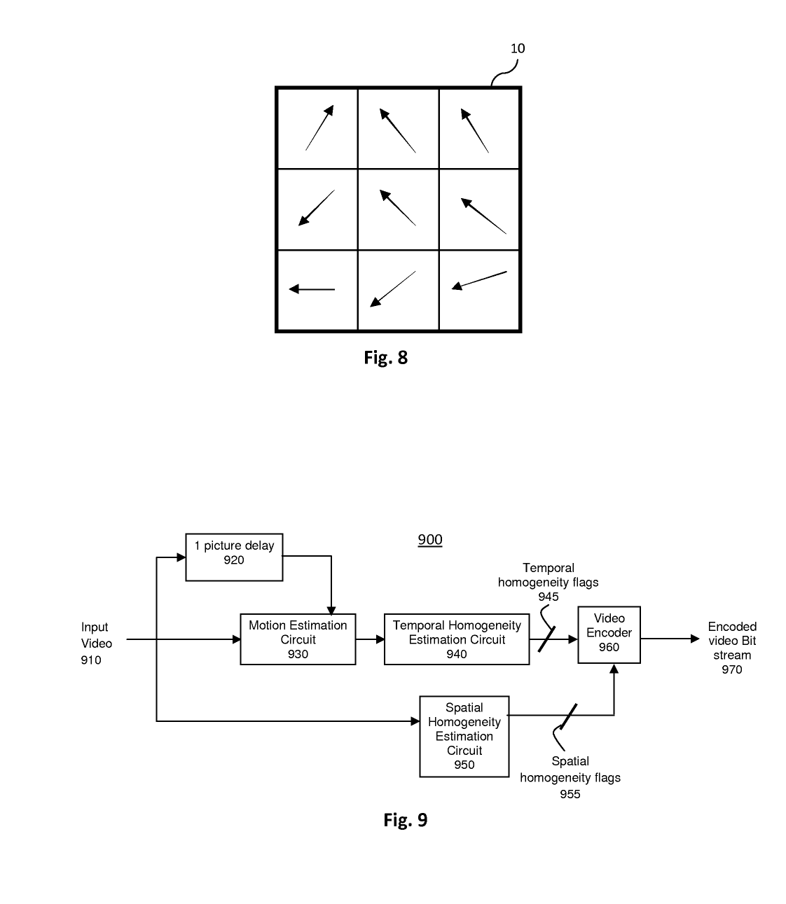

FIGS. 6 to 8 show specific examples of temporal homogeneity, in the cases of: full homogeneity 30 (FIG. 6) of a sampling window 10; partial homogeneity 40 (FIG. 7) of a sampling window 10; and no homogeneity (FIG. 8) of the sampling window 10.

A key component of the hardware that carries out the described method is the spatio-temporal homogeneity estimation circuit, 900, as shown in FIG. 9.

The spatio-temporal homogeneity estimation circuit 900 comprises a video input 910 providing an input video sequence into all of: a one picture (frame or field) delay 920, a motion estimation circuit 930 and a spatial homogeneity estimation circuit 950. The motion estimation circuit 930 also has the output of the one picture delay 920 as its other input. The output of the motion estimation circuit 930 is fed into the temporal homogeneity estimation circuit 940, which determines temporal homogeneity flags 945, based upon the temporal homogeneity analysis of the motion vectors of the macroblocks within the sampling window derived by the motion estimation circuit 930. These temporal homogeneity flags 945 are then provided to the video encoder 960 to guide the encoding process, as described in more detail below.

Meanwhile the spatial homogeneity estimation circuit 950 feeds its output spatial homogeneity flags 955 into the video encoder 960 to further guide the encoding process, as described in more detail below. The result is that the video encoder 960 parameters are adjusted according to the combined estimated spatio-temporal homogeneity as encapsulated in the respective homogeneity flags 945, 955, to produce an encoded video output bit stream 970.

The since temporal homogeneity is time based, the temporal estimation circuit 940 requires knowledge of the both the current and previous pictures (i.e. inter picture analysis), and gets this information from the motion estimation circuit 930. Whereas, the spatial homogeneity is purely based on the contents of the particular picture of interested at one point in time (i.e. intra picture analysis).

### Exploitation of Homogeneity Measures:

The above described method and hardware for the estimation of Spatio-Temporal homogeneity in video sequences produces homogeneity statistical parameters (flags) that indicate how similar each macroblock is to its immediate neighbours, in both time and space or both This information can be exploited in video coding methods by using it to influence the coding of neighbouring macroblocks in such a way that macroblocks with full homogeneity are coded with very similar, if not identical, coder settings, whilst macroblocks that are only partially homogeneous are coded with settings that vary to a greater degree.

Within commonly used video compression methods there are key encoding parameters that directly control the performance of the process whilst ensuring that it remains stable (for example ensuring that the smoothing buffer never over or under-flows). It is these encoding parameters that can be varied according to the homogeneity statistical parameters, derived as described above.

For example, the following encoding parameters may be adapted:

### Human Visual System Based Rate Distortion Optimization:

Each macroblock of a picture can be coded according to a different macroblock encoding mode. These encoding modes include: inter (between different pictures) mode, intra (within the same picture) mode, skip mode, and the like. Which of the various encoding modes is used for a particular macroblock depends on the following factors.

1) Picture type (I, P or B pictures);

### 2) Picture Structure (Field or Frame Pictures)

3) Coding Standard (H.264, MPEG2, etc).

Generally an encoder uses Rate Distortion Optimization to choose the best macroblock mode option to use. In this process, the distortion and rate for each particular macroblock encoding mode is computed or estimated, and the one with minimum distortion for a given rate/minimum rate is chosen. This process is called Rate Distortion Optimization based mode decision. In the prior art, the RDO decision may be incorrect, as traditional RDO doesn't take picture characteristics into account when making its decision. One such example is Intra macroblock encoding mode for P or B pictures in homogenous regions like grass in soccer sequences. Here, RDO may choose Intra option as the best option, but it may produce visual artefacts as the Intra option uses spatial prediction whereas neighbourhood can use temporal prediction.

Thus, Rate Distortion Optimisation (RDO) is the aspect of a coding process whereby a judicious balance is maintained between the need to reduce capacity (size of encoded video data), whilst maintaining an acceptable picture quality, but this process needs considerable knowledge of the behaviour of the image sequence to function correctly.

By learning about the detailed behaviour of surrounding image components (i.e. macroblocks) it is possible to measure the effect of RDO on coding performance, such that buffer management is optimised at a more detailed level. If this learning process can also be organised to take account of the sensitivity of the human visual system to various measures of the image being viewed, then RDO can be steered towards ensuring that whatever distortions do occur, they are constrained to affect parameters to which the human visual system has low sensitivity (e.g. chrominance bit depth). One such measure is the Regional Homogeneity proposed in this invention. Of itself a measure of homogeneity has little value, but when used to steer coding processes its value becomes very significant.

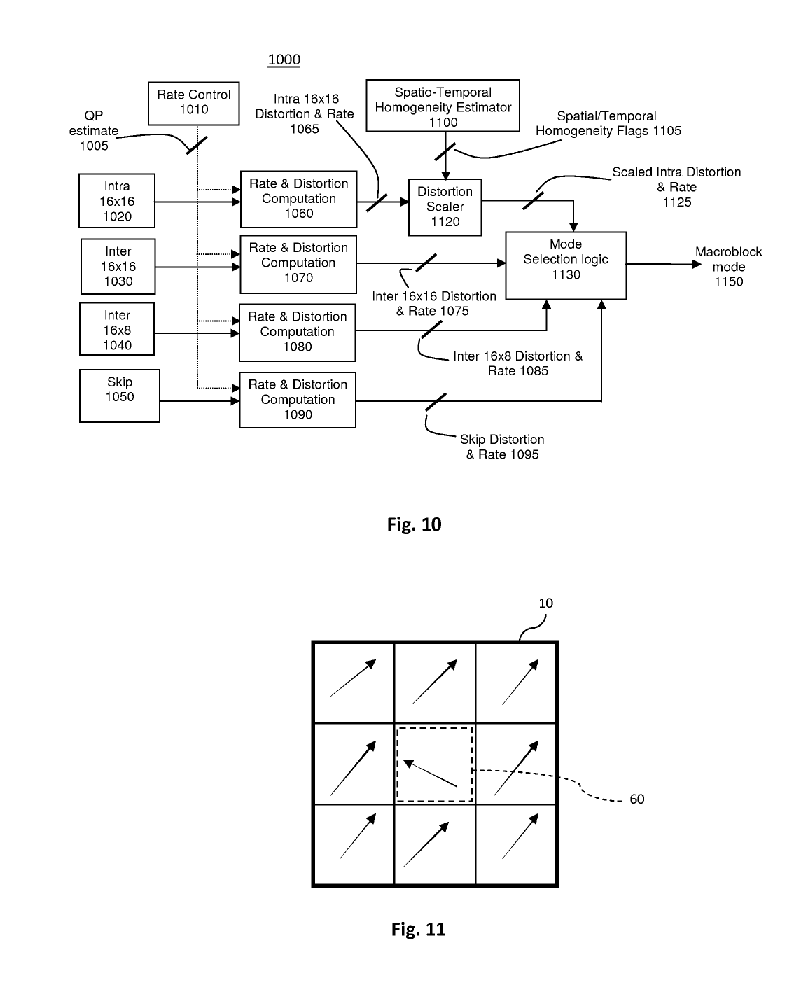

In RDO based mode decisions, various Intra and Inter encoding modes for the macroblock are evaluated and the best mode is chosen based on RDO criterion as shown in FIG. 10. Different intra and inter encoding modes exist for different video coding standards like H.264, MPEG2, etc. The known RDO criterion doesn't take the human visual system statistical parameters (i.e. characteristics) into account and are thus prone to produce visually annoying effects like flickering.

For example, in spatially and/or temporally homogeneous regions, it is not advisable to choose an intra macroblock encoding mode for temporally predictively coded pictures (P or B pictures), as it produces a flicker effect due to the mismatch in luminance levels. Changes in luminance levels can occur if the macroblock under consideration and its neighbourhood macroblocks have different prediction modes.

In more detail, FIG. 10 shows a portion of the video encoder including the spatio-temporal homogeneity estimation circuitry 1100 according to an embodiment of the present invention. It will be apparent that the spatio-temporal homogeneity estimation circuitry 1100 may form part of a pre-processing stage instead of being formed as part of the video encoder. However, since the video encoder already includes a portion of the hardware required by the spatio-temporal homogeneity estimation (for example, the Motion Estimation circuit 930), it is beneficial to reuse such hardware for the spatio-temporal homogeneity estimation circuitry 1100.

The Rate Distortion Optimization (RDO) based mode decision circuitry 1000 according to an embodiment of the invention comprises a rate control circuit 1010 and a number of encoding mode modules (intra/inter, skip, etc) 1020-1050. In particular, there are provided: a intra 16×16 encoding mode module 120; a inter 16×16 encoding mode module 1030; a inter 16×8 encoding mode module 1040 and a skip encoding mode module 1050.

The encoding modules 1020-1050 each feed into a rate and distortion computation circuit 1060-1090, which calculates the rate and distortion from the output of each encoding module 1020-1050, and the common output of the rate control circuit 1010. Each rate and distortion computation circuit 1060-1090 provides rate and distortion metrics 1065-1095 for the respective encoding mode modules 1020-1050. As described in more detail below, the Intra encoding module distortion metrics 1065 are scaled by distortion scaler 1120 according to the spatio-temporal homogeneity flags 1105 provided by the spatio-temporal homogeneity estimation circuit 1100, to provide scaled Intra rate and distortion metrics 1125. The rate is unchanged by the scaler.

The remaining encoding mode modules rates and distortion metrics are left as is. However, in alternative embodiments, these may also be scaled by some factor determined from the estimated spatio-temporal homogeneity flags.

Each of the three unscaled rate and distortion metrics 1075-1095, as well as the scaled intra encoding mode distortion metrics (and its associated, unscaled, rate) 1125 are inputted into a encoding mode selection logic block 1130, to choose the most appropriate encoding parameters for the macroblock of interest.

By using Spatial and temporal homogeneity flags, the intra macroblock encoding mode for temporally predicatively coded pictures can be discouraged by biasing the Intra mode distortion to improve the human visual system based perception of the encoded video. The bias depends on the extent of homogeneity. Strong bias is applied if the macroblock is fully homogeneous in both spatial and temporal domains and less bias is applied if the macroblock is only partially homogeneous in spatial or temporal direction.

The following pseudo code explains use of homogeneity flags, where if Intra mode distortion for the macroblock is IntraMB_Distortion, IntraMB_Distortion is weighted based on the extent of homogeneity.

If(Spatially fully homogenous and temporally fully homogenous)
{

Intra_mbDistortion = 2*mbDistortion;

}
Else if (Spatially partially homogenous and temporally partially
homogenous)
{

Intra_mbDistortion = 1.4* Intra_mbDistortion;

}
Else if (spatially fully homogenous or temporally fully homogenous)
{

Intra_mbDistortion = 1.25* Intra_mbDistortion;

}
Else if (spatially partially homogenous or temporally partially
homogenous)
{

Intra_mbDistortion = 1.10* Intra_mbDistortion;

}

Thus by biasing the distortion of Intra macroblock for homogenous regions flickering can be effectively reduced. The above specific bias factors have been found to be particular beneficial in real world tests of the described method and apparatus.

### Adaptive Quantisation Parameter:

In a simple implementation, the control loop around the smoothing buffer operates such that the quantisation parameter, QP, varies directly dependent on the buffer fill state. More particularly, if the buffer tends to fill, the value of QP is changed to cause the deletion and/or more severe quantisation of the Discrete Cosine Transform (DCT) components, which consequently reduces the number of bits entering the buffer. If the buffer tends to empty, the opposite is applied.

Whilst this certainly maintains buffer stability, it has an undesirable effect on picture quality due to the more severe quantisation at higher buffer fill levels. However, this process is essential to systems that employ fixed bit rate transmission channels between encoder and decoder.

It may be that the conditions that require the faster fill of the buffer are only short lived, and the buffer could actually be allowed to continue to fill with a lower severity of quantisation, through appropriate adjustment of the QP value, and still maintain stability whilst improving relative picture quality. Such an approach to managing the buffer is called Adaptive QP.

QP can be changed at the picture level, Slice level or at the macroblock level. Using Spatial and temporal homogeneity flags, Adaptive QP can be improved to encode homogenous macroblocks with same QP, e.g. by disabling adaptive QP at the macroblock level for macroblocks in the homogenous areas.

The following pseudo code is for the above example of homogeneity controlled Adaptive QP:

If (Spatial fully homogenous or Temporal fully homogenous)
{

Turn off the adaptive QP for macroblock and around its
neighbourhood.

}

### HVS Based Motion Estimation

Motion Estimation algorithms like Full Search tend to produce random or spurious motion vectors for flat regions (i.e. smooth blocks like grass in soccer sequences) due to noise and lack of sufficiently clear structure in the macroblock which can uniquely define the motion vector as shown in FIG. 11. In particular, it can be seen that macroblock 60 has a spurious motion vector value compared to motion vectors for the remaining macroblocks in the sampling window 10.

Using spatial homogeneity information, Motion Estimation can be enhanced for flat regions by biasing the macroblock motion vector towards neighbourhood motion vectors, thus generating the coherent motion vectors. This will reduce the bits required to code the motion vectors differentials as well as it improves the perceived video quality.

For example during motion estimation, Sum of absolute differences (SAD) can be biased as follows:

SAD at MV = SAD at MV + bias factor
bias factor = Threshold *[abs (Horizontal motion vector predictor −
Horizontal Current MV) + abs(Vertical motion vector predictor − Vertical
Current MV)]

For example In MPEG2, Motion vector predictor is the previous macroblocks motion vectors. Threshold is derived based on the extent of spatial homogeneity as follows:

If(Spatial Homogeneity Flag == Zero)
{

Threshold = 0;

}
Else if(Spatial Homogeneity Flag == Partially Homogenous)
{

Threshold = T1;

}
Else if((Spatial Homogeneity Flag == Fully Homogenous)
{

Threshold = T2;

}
Where T2 = 16 and T1 = 8 derived from the experimentation, and have
been found to be particularly beneficial in real world tests.

In the case of moving objects which doesn't exhibit any homogeneity bias factor would be zero. For homogenous regions, due to biasing of the SAD, motion estimation tends to produce coherent motion vectors.

By evaluating regional similarities in television images it is possible to improve the performance of video compression methods such as MPEG2 and MPEG4. By seeking out and rationalising regional homogeneity in the image, excessive local variations in coding parameters that lead to coding artefacts that are discernible by the HVS are avoided. Furthermore homogeneity variations over the image can be used to adapt the rate control mechanism more accurately thus reducing coding error and improving picture quality at a given bit rate.

The aforementioned method is typically carried out in a video pre-processor stage before the coding stage proper. However, it may be formed as part of the video encoder itself. In the case where the method is carried out by the video pre-processor, the pre-processor analyses video picture data prior to encoding proper, to determined information about the video including the homogeneity statistical parameters (flags), and to provide these parameters to the video encoder, such that the encoder is fore-warned of details about the video picture data, and can therefore optimise the output encoded video.

The above described method may be carried out by suitably adapted hardware. The method may also be embodied in a set of instructions, stored on a computer readable medium, which when loaded into a computer, Digital Signal Processor (DSP) or similar, causes the computer to carry out the hereinbefore described method.

Equally, the method may be embodied as a specially programmed, or hardware designed, integrated circuit which operates to carry out the method on image data loaded into the said integrated circuit. The integrated circuit may be formed as part of a general purpose computing device, such as a PC, and the like, or it may be formed as part of a more specialised device, such as a games console, mobile phone, portable computer device or hardware video encoder.

One exemplary hardware embodiment is that of a Field Programmable Gate Array (FPGA) programmed to carry out the described method, located on a daughterboard of a rack mounted video encoder, for use in, for example, a television studio or location video uplink van supporting an in-the-field news team.

Another exemplary hardware embodiment of the present invention is that of a video pre-processor made out of an Application Specific Integrated Circuit (ASIC).

It will be apparent to the skilled person that the exact order and content of the steps carried out in the method described herein may be altered according to the requirements of a particular set of execution parameters, such as speed of encoding, accuracy of detection, and the like. Accordingly, the claim numbering is not to be construed as a strict limitation on the ability to move steps between claims, and as such portions of dependent claims may be utilised freely.

1.-21. (canceled)

22. A method of encoding video data, comprising:
estimating the spatio-temporal homogeneity of at least one portion of the video data;
providing spatio-temporal homogeneity flags dependent upon the estimated spatio-temporal homogeneity of the at least one portion of the video data; and
guiding the encoding process dependent on the spatio-temporal homogeneity flags.

23. The method of claim 22, wherein the step of estimating the spatio-temporal homogeneity further comprises:
determining a spatial homogeneity of the portion of the video data and determining a temporal homogeneity of the portion of the video data, separately, and wherein the spatial and temporal homogeneity is separately determined to be any one of:
fully homogenous;
partially homogenous; or
non homogeneous.

24. The method of claim 23, wherein the video data comprises pictures having macroblocks, and the portion of video data comprises a sampling window of a predetermined number of macroblocks in a square formation, and a macroblock of interest is located in the centre of said sampling window.

25. The method of claim 24, wherein the sampling window comprises a square of nine macroblocks having the macroblock of interest surrounded by eight neighbouring macroblocks, and wherein:
fully homogenous comprises the case where the macroblock of interest has spatial or temporal characteristics matching the spatial or temporal characteristics of the eight neighbouring macroblocks;
partially homogeneous comprises the case where the macroblock of interest has spatial or temporal characteristics matching the spatial or temporal characteristics of at least five of the neighbouring macroblocks; and
non homogenous comprises all other cases.

26. The method of claim 24, wherein spatial homogeneity is determined from the absolute difference of the standard deviation of the macroblock of interest and the eight surrounding neighbour macroblocks.

27. The method of claim 24, wherein the macroblock of interest is considered to be part of a fully spatially homogeneous region if the absolute values of the differences between the standard deviations of the macroblock of interest and each of the eight surrounding neighbour macroblocks is less than or equal to a first predetermined value.

28. The method of claim 24, wherein the macroblock of interest is considered to be part of a partially spatially homogeneous region if the absolute values of the differences between the standard deviations of the macroblock of interest and at least five of the surrounding neighbour macroblocks is less than or equal to a first predetermined value.

29. The method of claim 24, wherein the macroblock of interest is considered to be part of a temporally homogeneous region if motion vectors of the macroblock of interest and motion vectors of a predetermined number of surrounding neighbour macroblocks are similar to a predetermined degree.

30. The method of claim 24, wherein the macroblock of interest is considered to be part of a fully temporally homogeneous region if a Manhattan distance between motion vectors of the macroblock of interest and each of the eight surrounding neighbour macroblocks is less than or equal to a second predetermined value.

31. The method of claim 24, wherein the macroblock of interest is considered to be part of a partially temporally homogeneous region if a Manhattan distance between motion vectors of the macroblock of interest and at least five of the surrounding neighbour macroblocks is less than or equal to a second predetermined value.

32. The method of claim 22, further comprising:
guiding a Rate Distortion Optimisation portion of the encoding process dependent on the spatio-temporal homogeneity flags.

33. The method of claim 32, wherein the step of guiding the Rate Distortion Optimisation portion of the encoding process comprises applying a first bias value multiple to the intra encoding mode distortion value.

34. The method of claim 22, further comprising:
guiding an Adaptive Quantization Parameter portion of the encoding process dependent on the spatio-temporal homogeneity flags.

35. The method of claim 34, wherein the Adaptive Quantization Parameter is turned off for the macroblock of interest if it is determined to be spatially fully homogeneous or temporally fully homogeneous.

36. The method of claim 22, further comprising:
guiding a motion estimation portion of the encoding process dependent on the spatio-temporal homogeneity flags.

37. The method of claim 36, wherein the step of guiding the motion estimation portion of the encoding process comprises adding a second bias value to the Sum of Absolute Differences for the macroblock of interest, wherein the second bias value comprises:
a first threshold whose value is dependent on the spatial homogeneity of the macroblock of interest multiplied by [abs (a horizontal motion vector predictor−a horizontal current motion vector)+abs (a vertical motion vector predictor−a vertical current motion vector)], wherein the first threshold value is dependent on the spatial homogeneity of the macroblock of interest.

38. A video encoding apparatus comprising:
a motion estimation circuit;
a one picture delay;
a temporal homogeneity estimation circuit;
a spatial homogeneity estimation circuit; and
logic adapted to provide spatio-temporal homogeneity flags for use by a subsequent video encoder.

39. The video encoding apparatus of claim 38, further comprising a distortion scaler, adapted to scale distortion values of an intra encoding mode of the video encoding apparatus, dependent on the output of the spatio-temporal estimation circuit.

40. The video encoding apparatus of claim 38, further comprising an encoding mode selection circuit adapted to select a macroblock of interest encoding mode dependent on the estimated spatio-temporal homogeneity.

41. A computer-readable medium, carrying instructions, which, when executed, causes computer logic to carry out a method of encoding video data, comprising:
estimating the spatio-temporal homogeneity of at least one portion of the video data;
providing spatio-temporal homogeneity flags dependent upon the estimated spatio-temporal homogeneity of the at least one portion of the video data; and
guiding the encoding process dependent on the spatio-temporal homogeneity flags.
